(19) United States
(12) Patent Application Publication
(10) Pub. No.: US 2026/0259349 A1
(43) Pub. Date: Sep. 3, 2026

(54) METHOD OF EARLY WARNING DETECTION FOR WIND SHEAR AT AIRPORT USING MACHINE LEARNING

(71) Applicant: National Institute of Meteorological Sciences, Seogwipo-si (KR)

(72) Inventors: Jae Hyeok SEOK, Seogwipo-si (KR); Su Hwan MOON, Jeju-si (KR); Hee Wook CHOI, Seogwipo-si (KR); Sang Sam LEE, Seogwipo-si (KR)

(73) Assignee: National Institute of Meteorological Sciences, Seogwipo-si (KR)

(21) Appl. No.: 19/552,242

(22) Filed: Feb. 27, 2026

(30) Foreign Application Priority Data
Feb. 28, 2025 (KR) 10-2025-0026820

(51) Int. Cl. G01W 1/10; G06N 7/01

(52) U.S. Cl. CPC G01W 1/10; G06N 7/01

(57) ABSTRACT

The present invention relates to a method of early warning detection for wind shear at an airport using machine learning, which can support decision-making in aviation weather forecasting, in that the early wind shear detection model exhibited the highest probability of detection (POD) in a one-hour-ahead prediction performance, and predicted occurrence cases with a high probability in a probabilistic time series distribution, thereby indicating that wind shear can be sufficiently detected in advance through machine learning and supporting decision-making in aviation weather forecasting.

### BACKGROUND OF THE INVENTION

### Field of the Invention

The present invention relates to a method of early warning detection for wind shear at an airport using machine learning, and more specifically, to a method of early warning detection for wind shear at an airport using machine learning that includes training meteorological observation data using an extreme gradient boosting (XGBoost) algorithm, training observational data from the time of wind shear occurrences and up to six hours prior, constructing prediction models at one-hour intervals, deriving occurrence or non-occurrence of wind shear from each model, and calculating probabilistic occurrence information through a weighted average, thereby supporting decision-making in aviation weather forecasting.

### Background Art

In general, wind shear refers to a sudden change in wind direction and wind speed. Low-level wind shear that occurs below approximately 500 meters (1600 feet) has potentially adverse effects on the performance and safe flight of an aircraft in operation [Non-Patent Document 1].

During a climb-out phase and an approach phase of flight, the speed and altitude of an aircraft are very important factors. If wind shear occurs, takeoff and landing become difficult, potentially leading to a go-around, diversion, delay, or cancellation, thereby threatening aviation safety and causing economic loss and passenger inconvenience.

To detect wind shear, studies utilizing an aerodrome meteorological observation system have been actively conducted.

In a study by the Aviation Meteorological Office (2023) [Non-Patent Document 2], synoptic-scale winds were classified based on data from the Marado buoy located 26 km offshore to the southwest of Jeju Island, and it was identified that a shear line forms at the point where southerly flows meet the winds curving around both sides of Mount Halla. In addition, it was confirmed that when southerly winds exceeding 25 kt blow from the south of Jeju Island, the winds cross over the summit of Mount Halla and descend along the mountain slope, resulting in strong winds and wind shear at Jeju Airport, which is located on the leeward side. Park Jong-su et al. (2008) [Non-Patent Document 3] analyzed the impact of strong winds on Jeju Airport according to wind pattern types and proposed a forecasting technique to respond to wind shear caused by strong southerly flows.

Although numerous case studies on wind shear have been conducted, for safe and smooth air traffic flow, it is necessary to provide prediction-based early information rather than post-observation reporting. Meanwhile, several studies related to wind shear prediction at Jeju Airport also exist [Non-Patent Documents 4 and 5]. However, most of the studies focus on wind changes within Jeju Airport, and such approaches have limitations in that they do not adequately consider winds crossing over Mount Halla.

### REFERENCES CITED

### Non-Patent Literature

[Non-Patent Document 1] ICAO, “Manual on Low-Level Wind Shear, First Edition,” International Civil Aviation Organization, p. 10, 2005.
[Non-Patent Document 2] AMO, “Study Collection of Wind Shear at Jeju Airport,” Aviation Meteorological Office, July 2023.
[Non-Patent Document 3] J. S. Park, H. N. Park, and S. Y. Sin, “Development of Strong Wind Forecast Guidance by Wind Direction at Jeju Airport,” Proceedings of the Autumn Meeting of KMS, pp. 386-387, 2008.
[Non-Patent Document 4] G.-H. Kim, H.-W. Choi, J.-H. Seok, and Y.-H. Kim, “Prediction of Low-Level Wind Shear Using a High-Resolution Numerical Weather Prediction Model at the Jeju International Airport,” Journal of the Korean Society for Aviation and Aeronautics, vol. 29, pp. 88-95, 2021.
[Non-Patent Document 5] B. H. Min, Y. H. Kim, H. W. Choi, H. S. Jeong, K. R. Kim, and S. B. Kim, “Low-Level Wind Shear (LLWS) Forecasts at Jeju International Airport Using the KMAPP,” Atmosphere, vol. 30, no. 3, pp. 277-291, 2020.
[Non-Patent Document 6] T. Chen and C. Guestrin, “XGBoost: A Scalable Tree Boosting System,” Proceedings of the 22nd ACM SIGKDD International Conference on Knowledge Discovery and Data Mining, pp. 785-794, 2016.

### SUMMARY OF THE INVENTION

Accordingly, the present invention has been made to solve the above-mentioned problems occurring in the prior arts, and it is an objective of the present invention to provide a method of early warning detection for wind shear at an airport using machine learning that can support decision-making in aviation weather forecasting by training meteorological observation data using an extreme gradient boosting (XGBoost) algorithm, training observational data from the time of wind shear occurrences and up to six hours prior, constructing prediction models at one-hour intervals, deriving occurrence or non-occurrence of wind shear from each model, and calculating probabilistic occurrence information through a weighted average.

It is another objective of the present invention to provide a method of early warning detection for wind shear at an airport using machine learning that can support decision-making in aviation weather forecasting, in that an early wind shear detection model exhibits the highest probability of detection (POD) in a one-hour-ahead prediction performance, and predicts occurrence cases with a high probability in a probabilistic time series distribution, thereby indicating that wind shear can be sufficiently detected in advance through machine learning and supporting decision-making in aviation weather forecasting.

To accomplish the above object, according to the present invention, there is provided a method of early warning detection for wind shear at an airport using machine learning including: a step of constructing a wind shear dataset using meteorological observation data and wind shear occurrence cases; a step of applying the wind shear dataset to an XGBoost algorithm; a step of constructing a single prediction model for forecasting each hour from one to six hours in advance using the wind shear dataset applied to the XGBoost algorithm; and a step of constructing a probabilistic prediction model by weighted-averaging the prediction performance of the single prediction models.

The method of early warning detection for wind shear at an airport using machine learning according to the present invention provides an effect of supporting decision-making in aviation weather forecasting by training meteorological observation data using an extreme gradient boosting (XGBoost) algorithm, training observational data from the time of wind shear occurrences and up to six hours prior, constructing prediction models at one-hour intervals, deriving occurrence or non-occurrence of wind shear from each model, and calculating probabilistic occurrence information through a weighted average.

According to the present invention, the method of early warning detection for wind shear at an airport using machine learning also provides an effect of supporting decision-making in aviation weather forecasting, in that the early wind shear detection model exhibited the highest probability of detection (POD) in a one-hour-ahead prediction performance, and predicted occurrence cases with a high probability in a probabilistic time series distribution, thereby indicating that wind shear can be sufficiently detected in advance through machine learning and supporting decision-making in aviation weather forecasting.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a table showing an example of selection of wind shear cases for explaining a method of early warning detection for wind shear at an airport using machine learning according to an embodiment of the present invention.

FIG. 2 is a map showing locations of meteorological observation equipment (AWS, buoy, wind profiler, and AMOS) used in a method of early warning detection for wind shear at an airport using machine learning according to an embodiment of the present invention.

FIG. 3 is a graph showing a POD matrix by key parameter configuration for explaining a method of early warning detection for wind shear at an airport using machine learning according to an embodiment of the present invention.

FIG. 4 is a flowchart for developing an early warning detection algorithm according to an embodiment of the present invention.

FIG. 5 is a graph showing performance results by prediction time of a wind shear prediction model applied to a method of early warning detection for wind shear at an airport using machine learning according to an embodiment of the present invention.

FIG. 6 is a graph showing a time series distribution of probabilistic prediction results applied to a method of early warning detection for wind shear at an airport using machine learning, according to an embodiment of the present invention.

FIG. 7 is a graph showing a time series distribution of wind shear probability prediction results applied to a method of early warning detection for wind shear at an airport using machine learning, according to an embodiment of the present invention.

### DETAILED DESCRIPTION OF THE PREFERRED EMBODIMENT

Preferred embodiments of a method of early warning detection for wind shear at an airport using machine learning according to the present invention will be described with reference to the drawings. It should be noted that there are various preferred embodiments, and through the embodiments, the objectives, characteristics, and advantages of the present invention can be better understood.

The present invention is directed to developing an early warning detection algorithm applying an artificial intelligence technique for responding to wind shear at an airport, for example, Jeju Airport, and proposing its applicability to aviation meteorological forecasting.

For the present invention, meteorological observation data from Jeju Island during the spring season (March to May) of 2021 to 2022 were trained using the XGBoost (extreme Gradient Boosting) algorithm. The model was trained on observational data from the time of wind shear occurrences and up to six hours prior, and prediction models were constructed at one-hour intervals. Each model determines whether wind shear occurs and also calculates the occurrence probability information through a weighted average.

As a result of performance evaluation using meteorological data from the spring season of 2023, the wind shear early detection model demonstrated the highest probability of detection (POD) in the one-hour-ahead prediction model, and showed a high probability of predicting actual wind shear occurrences in the probabilistic time-series distribution. Such results indicate that wind shear can be sufficiently detected in advance through machine learning-based training, and the method is expected to support decision-making in aviation weather forecasting.

In the present invention, in order to generate and provide prediction information of wind shear frequently occurring at an airport, e.g., Jeju Airport, an early warning detection model for wind shear at Jeju Airport using machine learning was developed and evaluated by utilizing diverse meteorological observation data collected across Jeju Island during the spring seasons of the three years from 2021 to 2023.

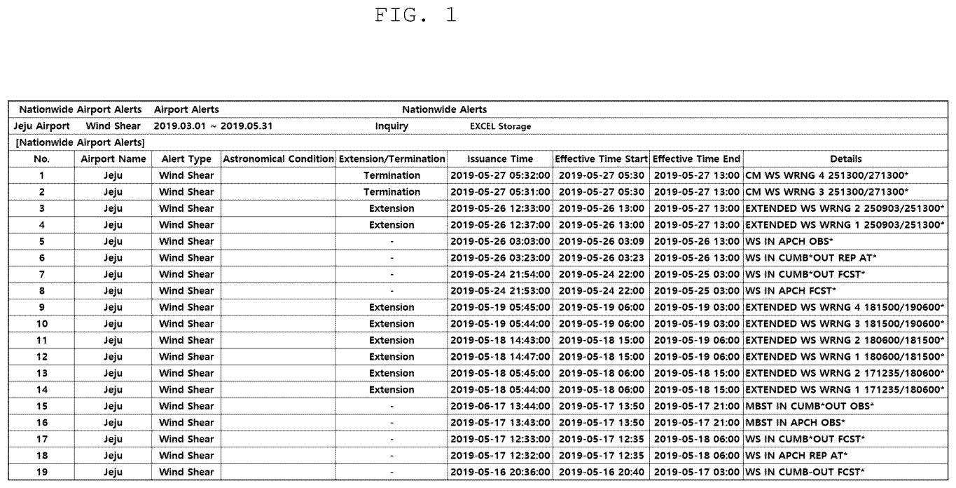

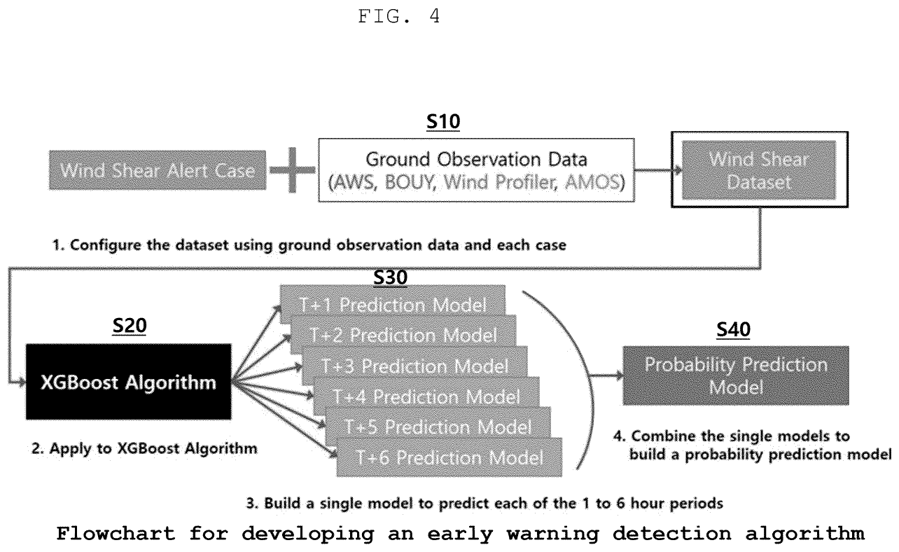

FIG. 1 is a table showing an example of selection of wind shear cases for explaining a method of early warning detection for wind shear at an airport using machine learning according to an embodiment of the present invention, and FIG. 4 is a flowchart for developing an early warning detection algorithm according to an embodiment of the present invention.

As illustrated in FIGS. 1 and 4, the method of early warning detection for wind shear at an airport using machine learning according to an embodiment of the present invention includes: a step (S10) of constructing a wind shear dataset using meteorological observation data and wind shear occurrence cases; a step (S20) of applying the wind shear dataset to an XGBoost algorithm; a step (S30) of constructing a single prediction model for forecasting each hour from one to six hours in advance using the wind shear dataset applied to the XGBoost algorithm; and a step (S40) of constructing a probabilistic prediction model by weighted-averaging the prediction performance of the single prediction models.

Specifically, the meteorological observation data in step S10 may include meteorological data observed from an automatic weather system (AWS), a marine weather observation buoy (BUOY), a wind profiler, and an aerodrome meteorological observation system (AMOS) provided by the Meteorological Administration. The wind shear occurrence cases in step S10 may include warnings issued at an airport where wind shear, which may adversely affect aircraft taking off or landing within 1,600 ft from a runway, is observed or expected to occur.

Moreover, according to the present invention, in step S20, the meteorological observation data and the wind shear occurrence cases are trained using the XGBoost algorithm.

Furthermore, according to the present invention, step S30 may include training the meteorological observation data and the wind shear occurrence cases using the XGBoost algorithm, and constructing the single prediction model by inputting past meteorological observation data up to six hours prior to the time of the wind shear occurrence case and training the data at one-hour intervals.

Additionally, according to an embodiment of the present invention, step S40 may include constructing a probabilistic prediction model by predicting probability using a binary classification method and applying the probability of detection and the false alarm ratio during the weighted averaging of the prediction performances of the single prediction model.

### EMBODIMENT

### [Wind Shear Occurrence Cases]

In the present invention, wind shear cases were selected using wind shear alarm data issued at Jeju Airport during the spring seasons (March to May) over three years from 2021 to 2023. The summary of wind shear alarm cases is presented in Table 1.

[Table 1] Summary of wind shear alarm cases at Jeju Airport during the spring seasons (March to May) from 2021 to 2023

| | 2021 | | | 2022 | | | 2023 | | | |
|---|---|---|---|---|---|---|---|---|---|---|
| | Mar | Apr | May | Mar | Apr | May | Mar | Apr | May | Sum |
| Wind | 75 | 183 | 155 | 112 | 50 | 27 | 81 | 148 | 149 | 980 |
| shear | | | | | | | | | | |
| alarm | | | | | | | | | | |

According to an embodiment of the present invention, the wind shear alarm data refer to alerts issued at each airport when wind shear is observed or expected to occur that may adversely affect aircraft taking off or landing within 1, 600 ft from a runway. The data are provided in a standardized format.

In this embodiment, the data were converted into hourly units for utilization. It was confirmed that 413 wind shear alarms were issued in 2021, 189 wind shear alarms in 2022, and 378 wind shear alarms in 2023. On a monthly basis, 268 wind shear alarms occurred in March, 381 wind shear alarms in April, and 331 wind shear alarms in May, but there was no significant difference in frequency among months.

The causes of wind shear occurrences at Jeju Airport during the spring season are known to include strong winds resulting from northerly winds, southerly winds (Yangbae winds) wrapping around Mount Halla from both sides, and the downslope wind phenomenon (known as “mulddeum”) caused by southerly winds crossing over Mount Halla [Non-Patent Document 2].

### [Construction of Early Warning Detection Model for Wind Shear]

According to an embodiment of the present invention, a machine learning technique, which is a type of artificial intelligence technique, was employed to objectively predict wind shear at an airport, for example, Jeju Airport. Machine learning enables the extraction of objective information for a target task by learning patterns from past data and constructing an algorithm.

In the present invention, the extreme gradient boosting (XGBoost) technique was used to construct an early warning detection model. The technique is one of the decision tree methods and is an ensemble model based on the gradient boosting machine (GBM). The GBM can minimize residuals between an actually observed value and a predicted value by using gradient descent during training. However, the learning process performed sequentially leads to slower computation. The XGBoost supports parallel computation to overcome the disadvantage of the GBM, allowing for faster training and classification. Thus, it is a prediction model capable of minimizing errors and applicable to various data formats [Non-Patent Document 6].

The XGBoost model determines the final prediction value by combining the outputs from each decision tree.

$$\hat{{y}_{i}} = ⌀ ( {x}_{i} ) = {{\sum }_{k = 1}}^{k} {f}_{k} ( {x}_{i} ) , {f}_{k} ∈ F , \qquad Equation 1$$

Equation 1 represents the formula for calculating the prediction value considering K trees in an ensemble model. F
means the set of classification and regression trees, and ƒₖ corresponds to each independent tree and the weight assigned to each leaf node. The final predicted value ŷᵢ is obtained by summing the output scores of all the leaves.

$$L ( ϕ ) = {\sum }_{i} l ( {y}_{i} , \hat{{y}_{i}} ) + {\sum }_{k} Ω ( {f}_{t} ) \qquad Equation 2$$

$$Ω ( f ) = γ T + \frac{1}{2} λ {‖ w ‖}^{2} \qquad Equation 3$$

Equation 2 represents the formula for the loss function used in the XGBoost model, wherein [symbol] is a predicted value, yᵢ is an actual value, and Ω(ƒₜ) denotes a regularization term.

The regularization term can be expressed by Equation 3, wherein T^{l} is the number of leaves, ω is the weight, and γ and λ are regularization parameters. The number of leaves γT and the weight of the leaves

$$\frac{1}{2} λ {‖ w ‖}^{2}$$

determine the model complexity.

$${L}^{( t )} = {{\sum }_{i = 1}}^{n} l ( {y}_{i} , {\hat{{y}_{i}}}^{( t - 1 )} + {f}_{t} ( {x}_{i} ) ) + Ω ( {f}_{t} ) \qquad Equation 4$$

Equation 4 represents the formula for training of the XGBoost model.

$${\hat{{y}_{i}}}^{( t - 1 )}$$

is a predicted value deduced at the t−1^{th} iteration, Ω(ƒₜ) and is the regularization function.

At the t−1^{th} iteration, the newly added tree function ƒₜ is adjusted to minimize the loss function and the regularization term, thereby reducing the residual error [Non-Patent Document 6].

The training data for the early warning detection model included wind shear occurrence cases during the spring seasons of 2021 to 2022, along with meteorological variables, such as wind speed, wind direction, and pressure, obtained from fifteen AWS sites, one wind profiler, and four AMOS stations.

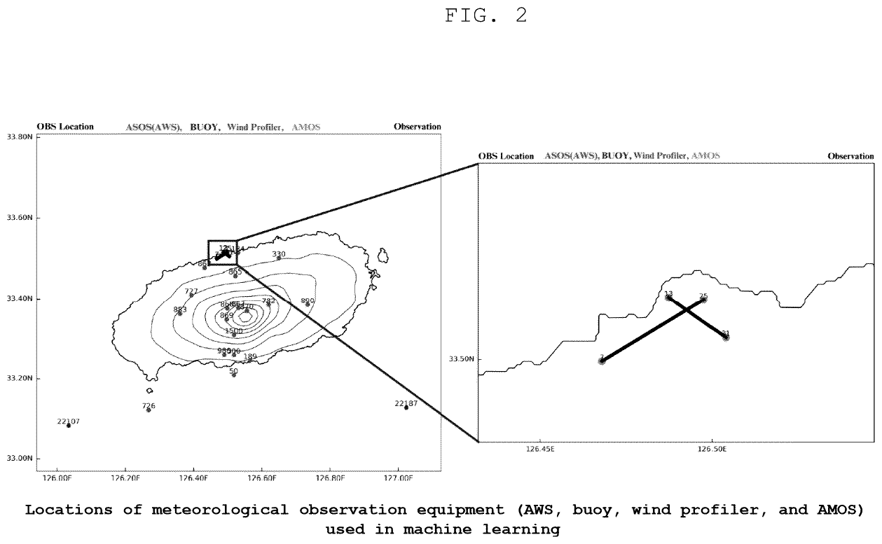

FIG. 2 is a map showing locations of meteorological observation equipment (AWS, buoy, wind profiler, and AMOS) used in a method of early warning detection for wind shear at an airport using machine learning according to an embodiment of the present invention.

As shown in FIG. 2, red dots indicate AWS sites, blue dots indicate BUOY sites, green dots indicate wind profiler sites, and light blue dots indicate AMOS sites. Wind profiler data at three altitudes (50 m, 500 m, and 1500 m) from the Seogwipo site (47884) were used.

TABLE 2
Contingency table between observation and forecast data

Event Observed

| | | |
|---|---|---|
| Contingency table | Yes | No |

| | | | |
|---|---|---|---|
| Event | Yes | TP | FP |
| Forecast | No | EN | TN |

According to an embodiment of the present invention, for early warning detection of wind shear, a model configured to input past observational data shifted by one-hour intervals up to six hours prior to the time of each occurrence case from a model trained observational data corresponding to the same time as the occurrence cases [Table 1] was constructed.

For example, if a wind shear event occurred at 12:00 on Mar. 1, 2021, a model was constructed by training on meteorological observation data observed at 12:00, and additional predictive models were constructed by training on observation data obtained at one-hour intervals from 11:00 back to 06:00, so as to enable prediction of the phenomenon using data up to six hours in advance.

Each of the total seven detection models outputs a binary classification, expressed as either presence (1) or absence (0) of the event.

Furthermore, to optimize the performance of the early warning detection model, key parameters of the XGBoost method were configured. The number of trees (N estimators) and maximum tree depth (Max_depth), which are representative parameters in decision tree-based machine learning, were selected as the major parameters. The values were tuned to identify the combination yielding the highest probability of detection (POD), which was then used as the final model parameter configuration. The POD is an evaluation metric used for binary classification models and represents the proportion of observed events that were correctly predicted by the model.

The POD can be calculated using Equation 5 based on the contingency table shown in Table 2.

In addition to POD, the false alarm ratio (FAR) was also used as a supplementary evaluation metric. The FAR represents the proportion of predicted events that did not actually occur and can be calculated using Equation 6. Both the POD and the FAR range between 0 and 1, with higher performance indicated by values of the POD closer to 1 and the FAR closer to 0.

$$POD = \frac{TP}{TP + FN} \qquad Equation 5$$

$$FAR = \frac{FP}{TP + FP} \qquad Equation 6$$

In Equation 5, TP refers to the number of cases in which the phenomenon occurred and the model successfully predicted the occurrence, and FN refers to the number of cases in which the phenomenon occurred but the model failed to predict it. In Equation 6, FP refers to the number of cases in which the phenomenon did not occur but the model incorrectly predicted the occurrence of the phenomenon.

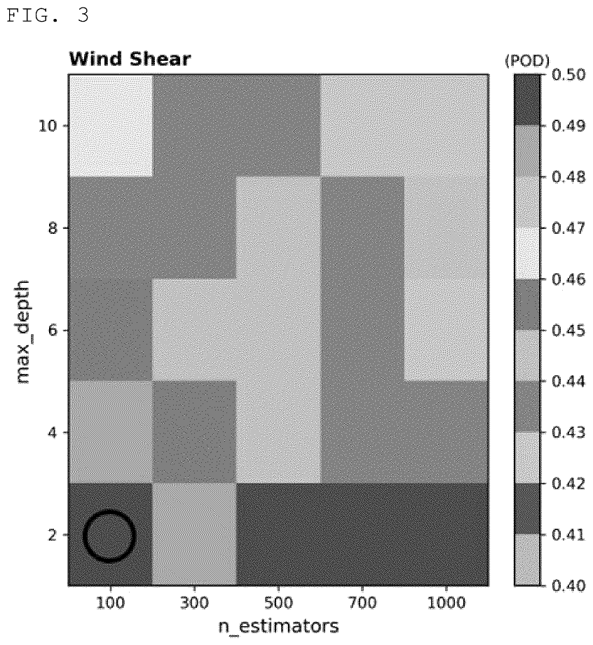

FIG. 3 is a graph showing a POD matrix by key parameter configuration for explaining a method of early warning detection for wind shear at an airport using machine learning according to an embodiment of the present invention.

As shown in FIG. 3, the X-axis represents the number of trees ranging from 100 to 1000, and the Y-axis represents the tree depth ranging from 2 to 10. When multiple parameter combinations yielded the same POD, the combination with lower resource consumption was selected to improve computational efficiency. In the wind shear prediction model, the combination of 100 trees and a tree depth of 2 showed the highest POD.

The key parameters applied to the final prediction model are shown in Table 3. Besides the number of trees and tree depth, the other parameters such as learning rate, subsample, and colsample_bytree were applied using default values.

TABLE 3
Key parameters applied to prediction model

| Parameter | Wind shear model |
|---|---|
| N_estimators | 100 |
| Max_depth | 2 |
| Learning_rate | 0.01 |
| Subsample | 1.0 |
| Colsample | 1.0 |
| POD | 0.51 |

According to an embodiment of the present invention, the early warning detection model was constructed using the Korea Meteorological Administration's Supercomputer No. 5. Supercomputer No. 5 is a system manufactured by Lenovo and was introduced in 2020. Supercomputer No. 5 is currently used for the operational execution of weather models and for the development of meteorological models by the Korea Meteorological Administration. The early warning detection model was developed using 12 CPU cores.

Observation data and wind shear occurrence cases were used to construct respective datasets. Each dataset for the corresponding event was applied to the XGBoost algorithm to construct the single model for predicting each forecast hour ranging from 1 to 6 hours. Each single prediction model yields binary results indicating whether the event occurs, and the prediction performance is evaluated. Each single prediction model outputs whether the phenomenon occurs, and the prediction performance thereof is evaluated.

Finally, a probabilistic prediction model is constructed by applying a weighted average to the prediction performance of the individual prediction models, and the prediction performance of the probabilistic prediction model is also evaluated.

### [Results of Early Warning Detection of Wind Shear Using Artificial Intelligence Technique]

### [Performance Evaluation of Early Warning Detection Model]

To evaluate the performance of the early warning detection model for wind shear using the XGBoost technique, wind shear occurrence cases during the spring season of 2023 and meteorological observation data within Jeju Island were utilized. The model performance was assessed using the probability of detection (POD) and the false alarm ratio (FAR) of prediction performance evaluation indices.

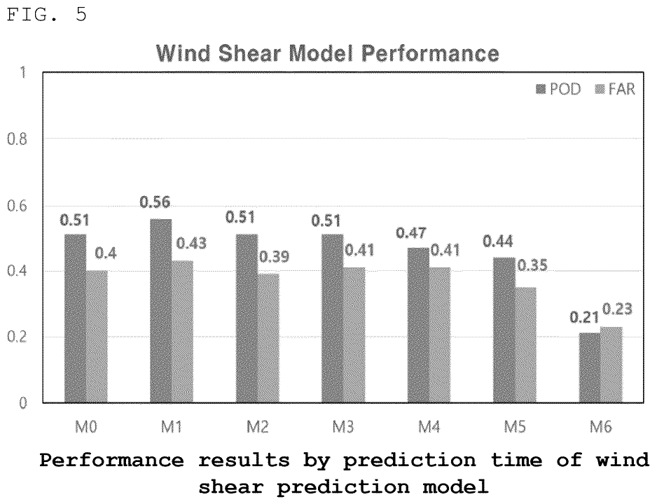

FIG. 5 is a graph showing performance results of POD and FAR by prediction time of a wind shear prediction model applied to a method of early warning detection for wind shear at an airport using machine learning according to an embodiment of the present invention.

As shown in FIG. 5, the POD and FAR of the model M0 trained using observation data corresponding to the same time as the occurrence cases were 0.51 and 0.40, respectively. The model M1, trained using observation data from one hour prior to the occurrence time, showed the highest POD of 0.56 and also the highest FAR of 0.43. The models M2 and M3 exhibited a POD of 0.51, and FARs of 0.39 and 0.41, respectively, indicating a decrease in prediction performance. The PODs of the models M4 through M6 further decreased to 0.47, 0.44, and 0.21, respectively, indicating significantly lower prediction performance. However, since the model M1 showed the highest prediction performance, it can be concluded that the meteorological conditions one hour prior to the occurrence have the greatest impact on the occurrence of wind shear at Jeju Airport.

### [Probabilistic Prediction Model for Early Warning Detection of Wind Shear]

In the performance evaluation of the early warning detection model, the deterministic performance of each individual model according to the prediction time was assessed. However, since each model provides only deterministic outputs, there exists uncertainty in predictions. In addition, such uncertainty poses challenges to the decision-making process in aviation weather forecasting when applying the early warning detection algorithm. Therefore, a probabilistic prediction model was constructed to realistically reflect the uncertainty of predictions and support more accurate decision-making processes.

The probabilistic prediction model for early warning detection was constructed using six individual early warning detection models (M6 to M1), which were trained using observation data from six hours to one hour prior, respectively.

Once deterministic prediction results are obtained from the models M6 to M1, they can be integrated to provide probabilistic prediction results for the occurrence of wind shear one hour in advance.

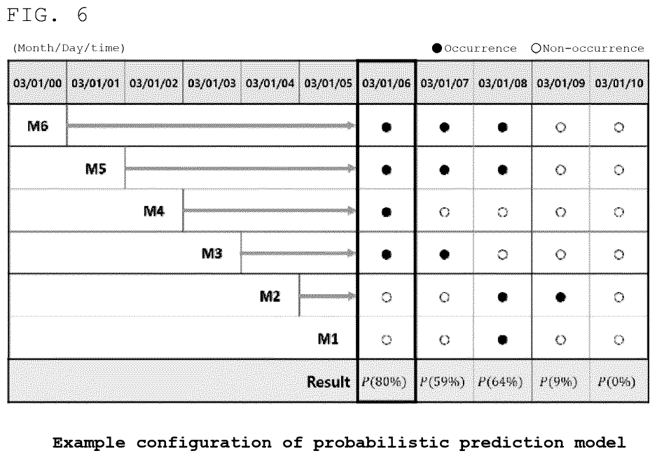

FIG. 6 is a graph showing an example configuration of a probabilistic prediction model applied to a method of early warning detection for wind shear at an airport using machine learning, according to an embodiment of the present invention.

As shown in FIG. 6, to predict a wind shear event at 06:00 on March 1, prediction data from Model M6, trained with observation data from 6 hours earlier, is generated at 00:00, and prediction data from Model M1, trained with data from 1 hour earlier, is generated at 05:00. When deterministic prediction results from Models M1 to M6 are obtained at 05:00, a final probabilistic prediction value is calculated using Equation 7 through a weighted average based on their detection performance.

Here, the detection performance refers to the POD results of Models M1 through M6. By applying the weighted average of the detection performance of each single prediction model, the reliability of the probabilistic prediction value can be improved.

Equation 7 represents the weighted average formula used to calculate the probabilistic prediction value P, and Equation 8 defines the formula for calculating the weighted value ωᵢ. Mᵢ denotes the prediction result of each model, and POD denotes the detection performance of each model.

$$P = {\sum }_{i = 1}^{6} {w}_{i} {M}_{i} \qquad Equation 7$$

$${w}_{i} = \frac{{POD}_{i}}{{\sum }_{n = 1}^{6} {POD}_{n}} \qquad Equation 8$$

During the spring of 2023, wind shear occurrence cases and probabilistic prediction results were plotted on a time series graph and their distribution was analyzed.

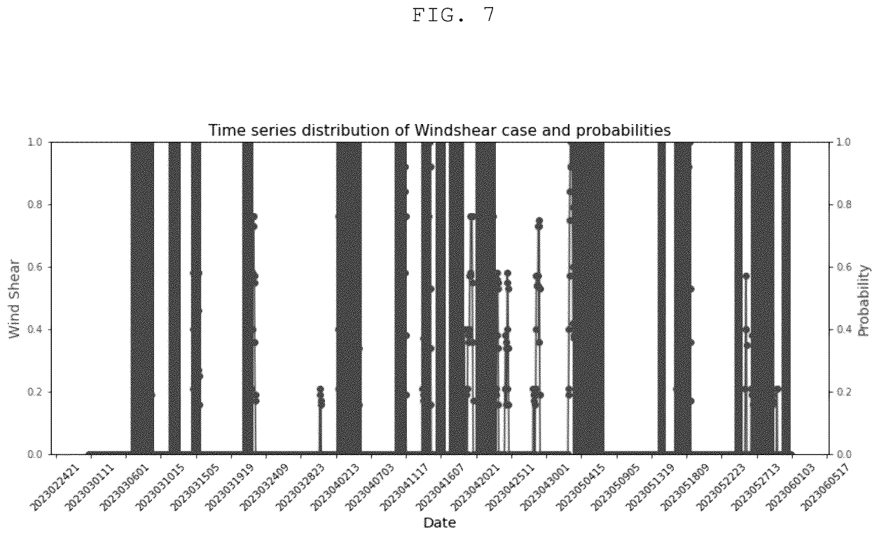

FIG. 7 is a graph showing a time series distribution of wind shear probability prediction results applied to a method of early warning detection for wind shear at an airport using machine learning, according to an embodiment of the present invention.

As shown in FIG. 7, green shaded areas represent wind shear warning occurrences in hourly intervals, and the red solid lines indicate the probability of wind shear occurrences. Wind shear warnings are often issued for several hours to days in preparation for expected occurrences. Hence, in the three-month time series graph, they are represented as shaded areas rather than solid lines. During the spring of 2023, wind shear warnings were relatively evenly distributed, and particularly dense warning periods were observed from mid-April to early May, indicating a high frequency of wind shear occurrences. It suggests that meteorological conditions during that period were favorable for wind shear occurrences. The probability predictions also tended to be higher in periods with high occurrence frequencies, indicating that the prediction model effectively captured overall wind shear occurrences. However, some false alarms were also identified between the periods with high occurrence frequency. It implies that although certain meteorological conditions observed by weather observation instruments may have signaled potential wind shear, no actual wind shear occurred due to other influencing factors.

Accordingly, to effectively respond to wind shear at an airport such as Jeju Airport, the present invention proposes a method of selecting wind shear events using weather models, and developed an early warning detection algorithm applying an artificial intelligence technique. Furthermore, applicability in the field of aviation weather forecasting is presented. To this end, wind shear warning data issued for Jeju Airport during the spring season (March to May) from 2021 to 2023 were utilized to select wind shear cases, and the data were converted into hourly units for use.

A total of 413 wind shear warnings were issued in 2021, 189 wind shear warnings in 2022, and 378 wind shear warnings in 2023. By month, 268 wind shear warnings were issued in March, 381 wind shear warnings in April, and 331 wind shear warnings in May.

For objective prediction of wind shear at an airport, such as Jeju Airport, the early warning detection model was constructed using XGBoost, one of the machine learning techniques. For model training, wind shear occurrence cases from 2021 to 2022 and meteorological observation data from automatic weather systems (AWS), wind profilers, and aerodrome meteorological observation systems (AMOS) around Jeju Airport and Mount Halla were used.

The early warning detection model was trained using observation data from the same time as the wind shear occurrence cases and data from up to six hours prior, at one-hour intervals. Through the above-mentioned process, a total of seven models were constructed, and the occurrence of wind shear was predicted using a binary classification method. To evaluate the detection performance of each prediction model, the probability of detection (POD) and the false alarm rate (FAR) were used.

According to the evaluation results, the prediction performance of the early warning detection model showed that the meteorological conditions one hour prior to the event had the greatest impact on wind shear prediction, and the performance decreased as the prediction time became longer. The model M1 showed the highest POD of 0.56 and the highest FAR of 0.43.

To realistically reflect the uncertainty of individual models and support decision-making, a probabilistic prediction model was also constructed by applying a weighted average to the outputs of the individual models from one to six hours prior. When analyzing the probabilistic prediction results for wind shear in the spring of 2023 in a time series, it was found that high prediction probabilities were observed during periods with a high frequency of actual occurrences, indicating good prediction performance. However, some false alarms were also identified, which were analyzed as cases in which meteorological conditions indicated the possibility of wind shear, but no actual occurrence was observed.

In the present invention, the method of early warning detection for wind shear at an airport using machine learning and the quantitative prediction performance were analyzed. In addition, the present invention is expected to support decision-making by aviation weather forecasters and related personnel by providing the probability of occurrence based on the model results.

### INDUSTRIAL APPLICABILITY

The present invention is applicable to the aviation weather forecasting industry utilizing early warning detection for wind shear at airports using machine learning.

What is claimed is:

1. A method of early warning detection for wind shear at an airport using machine learning, comprising:
a step S10 of constructing a wind shear dataset using meteorological observation data and wind shear occurrence cases;
a step S20 of applying the wind shear dataset to an XGBoost algorithm;
a step S30 of constructing a single prediction model for forecasting each hour from one to six hours in advance using the wind shear dataset applied to the XGBoost algorithm; and
a step S40 of constructing a probabilistic prediction model by weighted-averaging the prediction performance of the single prediction models,
wherein step S30 comprises training the meteorological observation data and the wind shear occurrence cases using the XGBoost algorithm, and constructing the single prediction model by inputting past meteorological observation data up to six hours prior to the time of the wind shear occurrence case and training the data at one-hour intervals.

2. The method according to claim 1, wherein the meteorological observation data in step S10 includes meteorological data observed from an automatic weather system (AWS), a marine weather observation buoy (BUOY), a wind profiler, and an aerodrome meteorological observation system (AMOS) provided by the Meteorological Administration, and
wherein the wind shear occurrence cases in step S10 comprise warnings issued at an airport where wind shear, which may adversely affect aircraft taking off or landing within 1,600 feet from a runway, is observed or expected to occur.

3. The method according to claim 1, wherein step S40 comprises constructing the probabilistic prediction model by predicting probability using a binary classification method and applying a probability of detection and a false alarm ratio during the weighted averaging of the prediction performances of the single prediction model.

4. The method according to claim 2, wherein step S40 comprises constructing the probabilistic prediction model by predicting probability using a binary classification method and applying a probability of detection and a false alarm ratio during the weighted averaging of the prediction performances of the single prediction model.
